(19) United States
(12) Patent Application Publication
(10) Pub. No.: US 2024/0119105 A1
(43) Pub. Date: Apr. 11, 2024

(54) TIME BASED AND COMBINATORIC OPTIMIZATION

(71) Applicant: Raytheon Company, Waltham, MA (US)

(72) Inventors: Ava K. Mistry, Littleton, CO (US); Monica Mayer Jacobs, Denver, CO (US); Jared Dean Stallings, Aurora, CO (US); Varian S. Little, Aurora, CO (US); Charles Giovanni Lebrun, Aurora, CO (US)

(73) Assignee: Raytheon Company, Waltham, MA (US)

(21) Appl. No.: 17/936,955

(22) Filed: Sep. 30, 2022

(51) Int. Cl. G06F 17/11

(52) U.S. Cl. CPC G06F 17/11

(57) ABSTRACT

A request is received for an answer to a problem comprising optimum assignment of a plurality of first entities to a plurality of second entities. A particle swarm optimization (PSO) is defined associated with a swarm comprising a plurality of particles, each particle location in the swarm representing an assignment of a first entity to a second entity. The PSO determines a set of solutions as a potential answer to the optimum assignment. A cost matrix is configured to analyze each solution PSO in accordance with a Hungarian algorithm, is configured to optimize at least one constraint associated with the pluralities of first and second entities and is applied to the set of PSO solutions generated to determine a cost score for each respective particle. The solution having the particle with best cost score is selected to be an optimized global best particle location for the next PSO iteration.

### FIELD

Embodiments of the disclosure generally relate to devices, systems, and methods for operation, scheduling, and optimizing performance of computer systems. More particularly, this disclosure relates at least to systems, methods, and devices to help create a lowest-cost schedule that takes advantage of varying costs of different assets performing different tasks and varying costs over time, to improve computer system performance.

### BACKGROUND

Optimization refers to a mathematical technique relating to finding the maxima or minima of functions in some known problem space or feasible region. A wide variety of businesses and industries are required to solve optimization problems. Often, a goal of optimization methods is to find an optimal or near-optimal solution with low computational effort. The effort of an optimization method can be measured as the time (computation time) and space (computer memory) that is consumed by the method. Methods and algorithms used to help solve solving optimization problems often are iterative in nature, requiring multiple evaluations to reach a solution. Various computational methods exist to help solve and/or optimize problems involving multiple entities operating in a given space, which can sometimes be subject to one or more constraints, and the constraints can be fixed or can vary. A variety of optimization techniques compete for the best solution.

### SUMMARY

The following presents a simplified summary in order to provide a basic understanding of one or more aspects of the embodiments described herein. This summary is not an extensive overview of all of the possible embodiments and is neither intended to identify key or critical elements of the embodiments, nor to delineate the scope thereof. Rather, the primary purpose of the summary is to present some concepts of the embodiments described herein in a simplified form as a prelude to the more detailed description that is presented later.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a method. The method also comprises (a) receiving a request for an answer to a problem, the problem comprising an optimum assignment of a plurality of first entities to a plurality of second entities; (b) defining, for the plurality of first entities and plurality of second entities, a particle swarm optimization (PSO), the PSO associated with a swarm comprising a plurality of particles, each particle having a respective particle location representative of at least one assignment of at least one first entity from the plurality of first entities to at least one second entity of the plurality of second entities, wherein the PSO is configured to determine at least one solution to the optimum assignment of the plurality of first entities to the plurality of second entities; (c) defining, for the plurality of first entities and plurality of second entities, a cost matrix configured to analyze each solution determined in the PSO in accordance with a Hungarian algorithm, wherein the cost matrix is configured to optimize at least one constraint associated with the plurality of first entities and plurality of second entities; (d) running a first iteration of the PSO on the plurality of first entities and plurality of second entities, to generate a first set of PSO solutions corresponding to at least one potential answer to the problem, each PSO solution corresponding to a respective particle at a respective particle location; (e) applying the cost matrix to the first set of PSO solutions generated to determine a cost score for each respective particle; and (f) selecting the solution having the particle with best cost score, in the first set of PSO solutions, to be an optimized global best particle location for a next iteration of the PSO. Other embodiments of this aspect include corresponding computer systems, apparatus, and computer programs recorded on one or more computer storage devices, each configured to perform the actions of the methods.

Implementations may include one or more of the following features. The method further comprises: (g) running a next iteration of the PSO using the optimized global best particle location determined in (e) as a location towards which particles in the PSO will swarm during the next iteration of the PSO, the next iteration generating an updated set of PSO solutions; and (h) returning a response to the request, the response to the request comprising a global best particle location from the next iteration of the PSO. The global best particle location from the next iteration of the PSO provides information necessary to provide a recommendation for the optimum assignment of the plurality of first entities to the plurality of second entities.

Implementations also may include one or more of the following features. The method further comprises (g) running a next iteration of the PSO using the optimized global best particle location determined in (e) as a location towards which particles in the PSO will swarm during the next iteration of the PSO, the next iteration generating an updated set of PSO solutions; (h) repeating steps (e) through (g) until a predetermined stop criteria is reached; and (i) returning a response to the request, the response to the request comprising a global best particle location based on the most recent iteration of the PSO that ran before the predetermined stop criteria was reached. The response to the request comprises information necessary to provide a recommendation for the optimum assignment of the plurality of first entities to the plurality of second entities. At least one of the plurality of first entities and the plurality of second entities comprises at least one of: a task to be performed, an entity capable of performing a task, an entity configured for having a task performed on it, a method of performing a task, a path for performing a task, a location for performing a task, a resource for performing a task, and an asset for performing a task. The constraint comprises at least one of: cost, time, efficiency, power consumption, resource utilization, and growth, a factor to be maximized, and an undesired effect to be minimized. Each respective particle location corresponds to an assignment of at least one first entity from the plurality of first entities to at least one second entity of the plurality of second entities, at a specific time. Implementations of the described techniques may include hardware, a method or process, or computer software on a computer-accessible medium.

One general aspect includes a system. The system also comprises a processor; and a non-volatile memory in operable communication with the processor and storing computer program code that when executed on the processor causes the processor to execute a process operable to perform the operations of: (a) receiving a request for an answer to a problem, the problem comprising an optimum assignment of a plurality of first entities to a plurality of second entities; (b) defining, for the plurality of first entities and plurality of second entities, a particle swarm optimization (PSO), the PSO associated with a swarm comprising a plurality of particles, each particle having a respective particle location representative of at least one assignment of at least one first entity from the plurality of first entities to at least one second entity of the plurality of second entities, wherein the PSO is configured to determine at least one solution to the optimum assignment of the plurality of first entities to the plurality of second entities; (c) defining, for the plurality of first entities and plurality of second entities, a cost matrix configured to analyze each solution determined in the PSO in accordance with a Hungarian algorithm, wherein the cost matrix is configured to optimize at least one constraint associated with the plurality of first entities and plurality of second entities; (d) running a first iteration of the PSO on the plurality of first entities and plurality of second entities, to generate a first set of PSO solutions corresponding to at least one potential answer to the problem, each PSO solution corresponding to a respective particle at a respective particle location; (e) applying the cost matrix to the first set of PSO solutions generated to determine a cost score for each respective particle; and (f) selecting the solution having the particle with best cost score, in the first set of PSO solutions, to be an optimized global best particle location for a next iteration of the PSO. Other embodiments of this aspect include corresponding computer systems, apparatus, and computer programs recorded on one or more computer storage devices, each configured to perform the actions of the methods.

Implementations may include one or more of the following features. The system further comprising providing computer program code that when executed on the processor causes the processor to perform the operations of: (g) running a next iteration of the PSO using the optimized global best particle location determined in (e) as a location towards which particles in the PSO will swarm during the next iteration of the PSO, the next iteration generating an updated set of PSO solutions; (h) repeating steps (e) through (g) until a predetermined stop criteria is reached; and (i) returning a response to the request, the response to the request comprising a global best particle location based on the most recent iteration of the PSO that ran before the predetermined stop criteria was reached. The response to the request comprises information necessary to provide a recommendation for the optimum assignment of assign the plurality of first entities to the plurality of second entities.

Implementations also may include one or more of the following features. The system further comprises providing computer program code that when executed on the processor causes the processor to perform the operations of: (g) running a next iteration of the PSO using the optimized global best particle location determined in (e) as a location towards which particles in the PSO will swarm during the next iteration of the PSO, the next iteration generating an updated set of PSO solutions; and (h) returning a response to the request, the response to the request comprising a global best particle location from the next iteration of the PSO. The global best particle location from the next iteration of the PSO provides information necessary to provide a recommendation for the optimum assignment of assign the plurality of first entities to the plurality of second entities. The constraint comprises at least one of: cost, time, efficiency, power consumption, resource utilization, and growth, a factor to be maximized, and an undesired effect to be minimized. Each respective particle location corresponds to an assignment of at least one first entity from the plurality of first entities to at least one second entity of the plurality of second entities, at a specific time. At least one of the plurality of first entities and the plurality of second entities comprises at least one of: a task to be performed, an entity capable of performing a task, an entity configured for having a task performed on it, a method of performing a task, a path for performing a task, a location for performing a task, a resource for performing a task, and an asset for performing a task. Implementations of the described techniques may include hardware, a method or process, or computer software on a computer-accessible medium.

One general aspect includes a computer program product including a non-transitory computer readable storage medium having computer program code encoded thereon that when executed on a processor of a computer causes the computer to operate a computer system. The computer program product also comprises (a) computer program code for receiving a request for an answer to a problem, the problem comprising an optimum assignment of a plurality of first entities to a plurality of second entities; (b) computer program code for defining, for the plurality of first entities and plurality of second entities, a particle swarm optimization (PSO), the PSO associated with a swarm comprising a plurality of particles, each particle having a respective particle location representative of at least one assignment of at least one first entity from the plurality of first entities to at least one second entity of the plurality of second entities, wherein the PSO is configured to determine at least one solution to the optimum assignment of the plurality of first entities to the plurality of second entities; (c) computer program code for defining, for the plurality of first entities and plurality of second entities, a cost matrix configured to analyze each solution determined in the PSO in accordance with a Hungarian algorithm, wherein the cost matrix is configured to optimize at least one constraint associated with the plurality of first entities and plurality of second entities; (d) computer program code for running a first iteration of the PSO on the plurality of first entities and plurality of second entities, to generate a first set of PSO solutions corresponding to at least one potential answer to the problem, each PSO solution corresponding to a respective particle at a respective particle location; (e) computer program code for applying the cost matrix to the first set of PSO solutions generated to determine a cost score for each respective particle; and (f) computer program code for selecting the solution having the particle with best cost score, in the first set of PSO solutions, to be an optimized global best particle location for a next iteration of the PSO. Other embodiments of this aspect include corresponding computer systems, apparatus, and computer programs recorded on one or more computer storage devices, each configured to perform the actions of the methods.

Implementations may include one or more of the following features. The computer program product further comprises: (g) computer program code for running a next iteration of the PSO using the optimized global best particle location determined by the computer program code in (e) as a location towards which particles in the PSO will swarm during the next iteration of the PSO, the next iteration generating an updated set of PSO solutions; and (h) computer program code for returning a response to the request, the response to the request comprising a global best particle location from the next iteration of the PSO. The global best particle location from the next iteration of the PSO provides information necessary to provide a recommendation for the optimum assignment of the plurality of first entities to the plurality of second entities. The response to the request comprises information necessary to provide a recommendation for the optimum assignment of the plurality of first entities to the plurality of second entities. Implementations of the described techniques may include hardware, a method or process, or computer software on a computer-accessible medium.

It should be appreciated that individual elements of different embodiments described herein may be combined to form other embodiments not specifically set forth above. Various elements, which are described in the context of a single embodiment, may also be provided separately or in any suitable sub-combination. It should also be appreciated that other embodiments not specifically described herein are also within the scope of the claims included herein.

Details relating to these and other embodiments are described more fully herein.

### BRIEF DESCRIPTION OF THE DRAWINGS

The advantages and aspects of the described embodiments, as well as the embodiments themselves, will be more fully understood in conjunction with the following detailed description and accompanying drawings, in which:

FIG. 1 is an exemplary illustration of an environment where the embodiments discussed herein can be advantageously implemented, in accordance with one embodiment;

FIG. 2 is a simplified block diagram of an exemplary system in accordance with one embodiment;

FIG. 3 is a flow chart showing an optimization process operable in the system of FIG. 2, in accordance with one embodiment

FIG. 4 is a diagram depicting operation of the system of FIG. 2 and the flowchart of FIG. 3, in accordance with one embodiment;

FIG. 5 is a functional flow diagram showing an example mode of operation for the system of FIG. 2 and the flowchart of FIG. 3, in accordance with one embodiment;

FIG. 6A is an illustrative example showing a plurality of cost matrices associated with a first iteration of a particle swarm optimization, showing the global best particle in the first iteration, in accordance with the process of FIG. 3, in accordance with one embodiment;

FIG. 6B is an illustrative example showing a plurality of cost matrices associated with a second iteration of a particle swarm optimization, showing the global best particle in the iteration, in accordance with the process of FIG. 3, in accordance with one embodiment;

FIG. 7 is a table showing how particles keep track of their own personal best match in accordance with the process of FIG. 3, in one embodiment; and

FIG. 8 is a block diagram of an exemplary computer system usable with at least some of the systems, processes, and examples of FIGS. 1-7, in accordance with one embodiment.

The drawings are not to scale, emphasis instead being on illustrating the principles and features of the disclosed embodiments. In addition, in the drawings, like reference numbers indicate like elements.

### DETAILED DESCRIPTION

Before describing details of the particular systems, devices, and methods, it should be observed that the concepts disclosed herein include but are not limited to a novel structural combination of modules, components, process steps, and/or circuits, and not necessarily to the particular detailed configurations thereof. Accordingly, the structure, methods, functions, control and arrangement of components and circuits have, for the most part, been illustrated in the drawings by readily understandable and simplified block representations, flowcharts, flow diagrams, and schematic diagrams, in order not to obscure the disclosure with structural details which will be readily apparent to those skilled in the art having the benefit of the description herein.

For convenience, certain concepts and terms used in the specification are collected here. The following terminology definitions, in alphabetical order, may be helpful in understanding one or more of the embodiments described herein and should be considered in view of the descriptions herein, the context in which they appear, and knowledge of those of skill in the art.

“Communications network” refers at least to methods and types of communication that take place between and among components of a system that is at least partially under computer/processor control, including but not limited to wired communication, wireless communication (including radio communication, Wi-Fi networks, BLUETOOTH communication, etc.), satellite communications (including but not limited to systems where electromagnetic waves are used as carrier signals), cloud computing networks, telephone systems (including landlines, wireless, satellite, and the like), networks communicating using various network protocols known in the art, military networks (e.g., Department of Defense Network (DDN)), centralized computer networks, decentralized wireless networks (e.g., Helium, Oxen), networks contained within systems (e.g., devices that communicate within and/or to/from a vehicle, aircraft, ship, spacecraft, satellite, weapon, rocket, etc.), distributed devices that communicate over a network (e.g., Internet of Things), and any network configured to allow a device/node to access information stored elsewhere, to receive instructions, data or other signals from another device, and to send data or signals or other communications from one device to one or more other devices.

“Computer system” refers at least to processing systems that could include desktop computing systems, networked computing systems, data centers, cloud computing and storage systems, as well as other types of processing systems comprising various combinations of physical and virtual processing resources. A computer system also can include one or more desktop or laptop computers, and one or more of any type of device with spare processing capability. A computer system also may include at least one data center or other type of cloud-based system that includes one or more clouds hosting tenants that access cloud resources.

“Cloud computing” is intended to refer to all variants of cloud computing, including but not limited to public, private, and hybrid cloud computing. In certain embodiments, a cloud computing architecture includes front-end and back end components. Cloud computing platforms, called clients or cloud clients, can include servers, thick or thin clients, zero (ultra-thin) clients, tablets and mobile devices. For example, the front end in a cloud architecture is the visible interface that computer users or clients encounter through their web-enabled client devices. A back-end platform for cloud computing architecture can include single tenant physical servers (also called “bare metal” servers), data storage facilities, virtual machines, a security mechanism, and services, all built in conformance with a deployment model, and all together responsible for providing a service.

“Satellite” at least refers to a manufactured object or vehicle intended to orbit the earth, the moon, or another celestial body, which can be used for one more military and/or civilian purposes, including but not limited to collection of information, communication, weather forecasting, transmission of television, radio, cable, and/or internet signals and communications, providing navigation signals (e.g., the Global Positioning System), collecting and communicating images of Earth and other objects, remote sensing of earth and space data, gathering intelligence information, as part of weapons systems, etc. A satellite typically carries radio equipment for connecting to a ground station. The ground station may be positioned between the satellite and one or more operator terminals, and it may be configured to relay data between the satellite and the operator terminals.

“Satlet” at least refers to a type of spacecraft which acts as an expendable resource. Satlets are stowed upon a mothership and can be deployed to perform specific tactical tasks. Satlets have minimal resources and are expected to live a short time (e.g., hours), just enough to perform a single action such as refueling, repair, etc.

“Mothership” at least refers to a type of spacecraft which is placed into orbit aligning with potential needs. Motherships are responsible for communicating with its assigned satlets and ground systems.

“Spacecraft” at least refers to vehicles and/or or machines designed to fly in outer space. In some examples, spacecraft act as a type of artificial satellite and can be used for a variety of purposes, including communications, Earth observation, meteorology, weather, as part of a weapons system, navigation, space colonization, planetary exploration, and transportation of humans and cargo. Spacecraft can operate with or without a human crew. Generally, known spacecraft (other than single-stage-to-orbit vehicles) are unable to get into space on their own, and require a launch vehicle (e.g., a carrier rocket).

Unless specifically stated otherwise, those of skill in the art will appreciate that, throughout the present detailed description, discussions utilizing terms such as “opening”, “configuring,” “receiving,”, “detecting,” “retrieving,” “converting”, “providing,”, “storing,” “checking”, “uploading”, “sending,”, “determining”, “reading”, “loading”, “overriding”, “writing”, “creating”, “including”, “generating”, “associating”, and “arranging”, and the like, refer to the actions and processes of a computer system or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices. The disclosed embodiments are also well suited to the use of other computer systems such as, for example, optical and mechanical computers. Additionally, it should be understood that in the embodiments disclosed herein, one or more of the steps can be performed manually.

Before describing in detail the particular improved systems, devices, and methods, it should be observed that the concepts disclosed herein include but are not limited to a novel structural combination of software, components, modules, and/or circuits, and not necessarily to the particular detailed configurations thereof. Accordingly, the structure, methods, functions, control and arrangement of components and circuits have, for the most part, been illustrated in the drawings by readily understandable and simplified block representations and schematic diagrams, in order not to obscure the disclosure with structural details which will be readily apparent to those skilled in the art having the benefit of the description herein.

The following detailed description is provided, in at least some examples, using the specific asset-target task assignment context of an exemplary system that optimizes maneuvers to form pairs of space objects (e.g., satlets and targets), but this system and application is illustrative and not limiting. Those of skill in the art will realize that the embodiments and aspects discussed herein have applicability in many different fields and applications, as well as many different types of assignment problems, and modifications and/or additions that can be made to such a system to achieve the novel and non-obvious improvements described herein.

Consider an environment such as outer space, which may include multiple spaceborne objects, such as motherships with stowed satlets, in constant motion. In some environments, satlets and other space vehicles are usable to help provide on-orbit servicing (OOS) to various types of target spacecraft, where the OOS can include repair, replacement, refueling, inspection, assisting with maneuvers, and many other tasks. As is understood, the complexity of the space environment can lead to various types of failures in entities that travel in space, are disposed in space, and/or are orbiting in space, such as spacecraft (including robotic spacecraft and manned spacecraft), satellites, satlets, rockets, spaceships, and space shuttles. Rather than re-launching other spacecrafts to replace the damaged, malfunctioning, or otherwise unusable spacecraft assets, it can be more cost effective to take advantage of OOS technology to perform necessary tasks. New types of space vehicles, such as satlets, are being developed and used to help with OOS tasks.

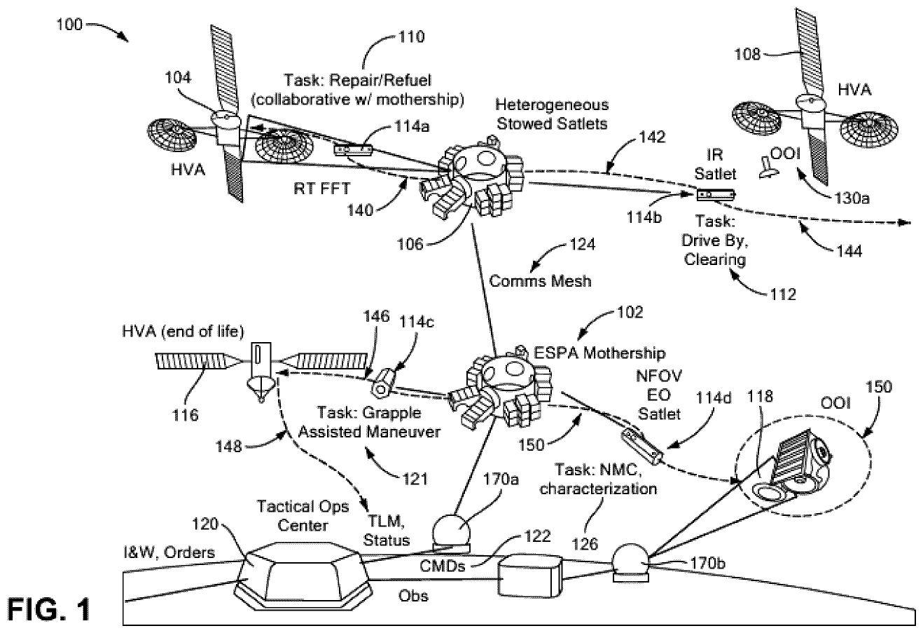

FIG. 1 provides an exemplary illustration of motherships and satlets performing OOS missions to provide context for the utility and application of the TIME BASED AND COMBINATORIC OPTIMIZATION approach described herein. FIG. 1 represents an example environment 200 that is a space environment where multiple satlets can be deployed from motherships to perform various types of OOS to various spacecraft. For simplicity, FIG. 1 represents a limited constellation of motherships and satlets, while the TIME BASED AND COMBINATORIC OPTIMIZATION approach supports much larger constellations with motherships in various orbital regimes to service a variety of satellites within the operational space environment. As will be apparent in this disclosure, the environment of FIG. 1 is but one example of a type of environment where certain target satellites in need of specific services can be paired with satlets that have the capability to perform that service. In at least some environment, “optimal” refers to a configuration that brings a desired level of success or advantage, maximizes a desired aspect or quality, such as cost, efficiency, time, power consumption, growth, communications, etc., and/or which minimizes one or more undesired aspects, such as waste, decay, unwanted side effects, etc.

Referring to FIG. 1, a first Evolved Expendable Launch Vehicle (EELV) ring Secondary Payload Adapter (“ESPA”) acts as an example mothership 102 and a second example ESPA mothership 106 are in operable communication via a satellite mesh communications network (“COMMS MESH 124”). The first mothership 102 and second mothership 106 each include a plurality of example respective heterogeneous stowed satlets 114a-114d that can be deployed from the respective mothership 102 and directed to perform one or more tasks. Once deployed, these satlets become part of the COMMS MESH 124. A deployed satlet must maintain communications through the COMM MESH while traveling to the target location and during its OOS mission. As shown in FIG. 1, the second ESPA 106 is commanded to launch first satlet 114a and second satlet 114b, and the first ESPA 102 is commanded to launch third satlet 114c and fourth satlet 114d. An Earth-based tactical operations (OPS) center 120 can receive one or more telemetry, Indications and Warnings (I&W) or other information about the constellation and can send commands 122 to the mothership 102 and 106 and any deployed satlets. In certain embodiments, a mothership such as mothership 102, is in operable communication with a first Earth-based satellite antenna system 170a. In certain embodiments, a second Earth-based satellite antenna system 170b, may be in operable communication with one or more space vehicles, such as space vehicle 118. In certain embodiments, each satlet has a mission capability, and the ESPA holds various types of satlets. A satlet is deployed to perform a job given its capability, and at least some of the embodiments discussed herein help illustrate processes that enable how to plan to get the satlets to their destinations in the most efficient way. It will be understood that the environment of motherships and satlets are provided to be illustrative and that the principles and processes described in this planning and optimization are applicable to other environments and scenarios.

Each of the satlets 114a-114d (collectively, “satlets 114”) is commanded and controlled, e.g., by one of the ESPA motherships 102, 106, or an earth-based communications system (e.g., tactical operations center 120) to position themselves within proximity of certain spacecraft (“targets”) and then perform certain OOS tasks on certain spacecraft (“targets”). For example, first satlet 114a is commanded to perform a repair/refuel task 110 on first high value asset (HVA) spacecraft 104. The first satlet 114a travels along first path 140, and the repair/refuel task is performed collaboratively with the second ESPA mothership 106, on first high value asset (HVA) spacecraft 104. The second satlet 114b is commanded to perform a drive by inspection task 112 on second HVA spacecraft 108 as it travels along second path 142 and third path 144. Although not visible in FIG. 1, as those of skill in the art will appreciate, the second satlet 114b, once complete with its task, will continue along third path 144 and be decommissioned. Third satlet 114c is configured to perform a grapple assisted maneuver task 121 on third HVA spacecraft 116, which is designated as an “end of life” HVA. Third satlet 114c travels a fourth path 146 to perform the grapple assisted maneuver and then continues along fifth path 148 to be decommissioned. The object of interest (OOI) 130a, in certain embodiments, corresponds to a type of target. There may be multiple objects of interest (such as satellites). In certain embodiments, OOIs can have appearances that differ from each other (e.g., a CubeSat (miniaturized satellite) may have a different appearance than a weather satellite). FIG. 1 shows an environment where there are multiple OOIs (targets), where they may look different, and all of the OOIs may have a different needs (e.g., characterization, inspection, etc.) depending on the target.

Fourth satlet 114d travels along sixth path 150 (which sixth path 150 includes an object of interest (OOI) portion. Fourth satlet 114d is commanded to perform an inspection task of space vehicle 118, which itself is in communication with a second Earth-based satellite antenna system 170b. Additional tasks, such as a characterization task 126, also can be performed.

Various constraints, conditions, limitations, and/or other requirements (collectively, “constraints”) also may apply in an asset-target task environment such as the environment 100 shown in FIG. 1 which can impact an asset's “cost” of performing a task to or for a target. The constraints can take into account any application specific factors, including but not limited to power or fuel cost, time to perform a maneuver, time for an asset to reach a target, resources required to perform a task (e.g., capabilities of an asset), etc. For this hypothetical taking place in the environment of FIG. 1, assume that “cost” refers to cost of and quantity of fuel consumption associated with the asset performing a given task, where fuel consumption also involves and may be related to at least the time it takes for the asset (e.g., a satlet 114a-114d) performing a task as well as possibly the fuel needed for the satlet to travel to the asset (e.g., HVA spacecraft) upon which the task is being performed. For example, in the environment 100 of FIG. 1, assume that the cost of the repair/refuel task 110 is, in and of itself (i.e., independent of travel time), inherently a greater cost than the cost of the drive by inspection task 112, because the repair/refuel task 110 inherently takes longer than the drive by inspection task 112 and requires additional fuel to “stop,” to match the orbit of its target. Another reason the cost of repair/refuel might be inherently longer is that it also requires the cost of the fuel used for refueling, which may cost less than resources used for drive by inspection. Thus, in this hypothetical, an additional assumption can be to assume that the cost of the repair/refuel task 110 can itself vary, not just based on travel time, but also based on amount of fuel required (different sized targets may require more or less fuel during refueling, which increases or decreases the time a satlet 114a-114d requires to perform a repair/refuel task 110).

Further, in this hypothetical, assume that the cost of the drive by inspection task 112 also can have a varying cost, depending on other factors, such as the timing of the inspection task. If the satellite (“target”) can only support the inspection task within a constrained time window, the ability of a satellite to reach the target to perform the task within that window may increase the required fuel cost, whereas a larger window may offer options for lower fuel cost maneuvers for the satlet to reach the target, due to the dynamic orbital constraints of maneuvering the satlets from the mothersat deployed location to the target inspection location. Further constraining the planning of the flyout of the satlet to the target location, a low fuel cost path may be found, but for which the comm mesh cannot be maintained due to visibility to ground or other space elements, resulting in a low cost, but infeasible path as the satlet requires communications to execute the OOS mission.

It can be seen that just the above variations in parameters, in the hypothetical situation, can make an optimization in this environment of FIG. 1, difficult to solve, because of varying constraints and varying costs, time, and resources associated with the varying constraints. One of skill in the art can appreciate that similar types of optimization challenges can occur in many other environments (e.g., a retailer attempting to determine how best to route delivery trucks to deliver purchases while also determining whether to subcontract to other providers, use drones, take into account traffic conditions at varying times, take into account weight of packages to be delivered which impacts fuel economy of delivery vehicle, etc.).

As can be seen in the environment of FIG. 1, there are applications where it is necessary to be able to have multiple assets (e.g., satlets) perform varying tasks, often at the same time, to varying targets (e.g., one or more high value space vehicles)—possibly while both assets and targets are in motion and/or when the targets also may be performing other tasks (e.g., a space vehicle that is providing satellite weather surveillance, for example), with varying costs. It is advantageous if the planning and execution of the assets performing tasks is performed in the most optimized way, which can take into account, advantageously, multiple parameters at once, such as cost, time, and resources. In environments with the complexity of that shown in FIG. 1, to be able to optimize which asset performs which tasks at which times, at the lowest cost (or at the most optimum other desired parameter), and with the ability to perform the task, it also may be necessary to take into consideration multiple different, sometimes competing factors, including but not limited to: whether an asset is capable of performing a task, the location of an asset at a given time, the speed an asset can travel to get to the target (as well as the speed of the target), the time it will take to perform a task, the cost (e.g., fuel consumption) required, whether cost varies based on other factors, such as time or location, whether speed or time to perform a task varies based on other factors, etc. Thus, there is a need for tailoring, modifying, and adapting available optimization solutions to meet the needs of such challenging environments.

Various types of solutions exist to the problem of optimizing the scheduling and/or assignment of assets to targets, or assets to tasks. Some solutions may take advantage of either combinatorial or time-based optimization. Often, these solutions only optimize one factor at a time. For example, if there are various assets to perform various tasks, a solution may focus on combinatorial optimization to schedule assets that can perform a given task, to targets that require that task. In at least some scheduling algorithms, such as Moore's Scheduling Algorithm, scheduling various tasks focuses only on ensuring that tasks are performed on time, rather than ensuring that the tasks are performed at the lowest cost possible. In addition, the majority of cost-based scheduling algorithms focus on the cloud computing problem space and do not take into account differing costs or capabilities in other environments.

Multiple different processes and methods have been used to help optimize situations where there are a plurality of different kinds of entities interacting in an environment, where it is desired to know which combinations, pairings, orderings, or other configurations of the entities, can produce an optimized result, such as a lowest cost, a quickest response, a most efficient utilization, etc. For example, one mathematical technique that is useful in some situation is the “Hungarian Matching Algorithm” (also known in the art and referred to herein as the “Kuhn-Munkres” algorithm, the “Munkres” algorithm, the “Munkres Assignment” algorithm, “Hungarian algorithm” and/or “Bipartite Graph Matching” algorithm). For simplicity herein, it will be termed the “Hungarian algorithm.” The Hungarian algorithm is a combinatorial type of optimization algorithm that is configured to solve an assignment linear-programming problem in polynomial time. The Hungarian algorithm can be configured to optimize problems that involve assigning assets to tasks, such as identifying minimum costs when assets are assigned to specific activities based on cost. This algorithm can be especially useful in some types of assignment problems (assigning a first entity to a second entity, from groups of first entities and groups of second entities), because the Hungarian algorithm enables finding the optimal solution without having to make a-direct comparison of every solution. The Hungarian algorithm operates using a principle of reducing a given cost matrix to a matrix of opportunity costs, where opportunity costs help to show relative penalties associated with assigning resources to a task in favor of assigning resources to a task or activity based on a best or least cost assignment.

A further application of the Hungarian algorithm is solving a problem of finding the shortest route or path possible when an asset must travel to multiple separate locations. Another application of this algorithm involves allocating resources to static locations (e.g., a set of sensors that monitor moving targets) in a way that optimizes the performance of the resources. The Hungarian algorithm and yet another example application of it is explained further in commonly assigned U.S. Pat. No. 8,010,658, entitled “INFORMATION PROCESSING SYSTEM FOR CLASSIFYING AND/OR TRACKING AN OBJECT,” which is hereby incorporated by reference (in this reference, the Hungarian algorithm is referred to as the Munkres algorithm).

Another computational method used for problem solving is Particle Swarm Optimization (PSO), which is a meta-heuristic, stochastic optimization technique that is based on the collective behavior of elements in decentralized and self-organized systems (e.g., the intelligent collective behavior of social swarms in nature, such as schools of fish or flocks of birds). PSO was developed based on an analysis of the “smart” behavior of such social swarms of natural entities, modeling their behavior as they are searching for an optimal source of food. For example, with a swarm of birds, a given bird's next movement can be influenced by its most recent movement, its own knowledge, and the swarm's knowledge. In terms of finding food, the next movement of a given bird in a swarm thus may be based on current movement, the best food source the given bird ever visited, and the best food source any bird in the swarm ever visited. PSO methods and algorithms attempt to simulate this social behavior found in nature to optimize certain types of computational problems, by iteratively trying to improve a given candidate solution with regard to a given measure of quality. In some applications, PSO is applied as a substantial branch of Artificial Intelligence (AI).

In PSO, each member of the population is referred to as a “particle,” and the population is referred to as a “swarm.” In an exemplary mathematical example, in an application of PSO, each potential solution to a given problem is viewed as a particle (a potential solution) with a certain velocity flying through the space of the problem, similar to a flock of birds. Thus, given a population of candidate solutions (particles), the particles are moved around a given search space according to a mathematical formula, over the particle's position and velocity. The particles are supposed to swarm towards the best candidate solution.

PSO traditionally starts with a randomly initialized population (the swarm) that is moving in randomly chosen directions, where each particle traverses the searching space and remembers the best previous positions of itself and its neighbors. In the swarm, similar to bird behavior, the particles communicate “good” or “optimum” positions to each other while at the same time, the particles dynamically adjust their own position and velocity derived from the best position of all particles. Changes to the position of particles within the search space are based on a tendency of individuals to emulate the success of other individuals. Thus, as with the bird example, with PSO, the movement of a given particle in the “swarm” of candidate solutions, is influenced by the local best known position of the given particle (“pbest”), but the particle's movement also is guided towards the best known positions in the search space, which positions are updated as better positions are found by other particles in the swarm (global best, also called “gbest”). Improved positions help to guide the movements of the swarm. Thus, in the iterative process of PSO to search for solutions, the particles effectively stochastically return toward previously successful regions in the search space.

In the performance of a PSO-based process, each particle adjusts its traveling velocity dynamically, according to the flying experiences of the particle and the colleague particles in the group. Importantly, as alluded to above, as a part of the PSO process, each particle keeps track of: (a) its own personal best result (“pbest,” as noted above) and (b) the best value of any particle in the group, (“gbest,” as noted above). As the particles move in the swarm, over the iterations in the PSO, each particle modifies its position according to several factors, including the particle's current velocity, the particle's current position, the distance between the particle's current position and pbest, and the distance between the particle's current position and gbest.

As the PSO process is repeated/iterated, it is hoped (but not always guaranteed) that the swarm will be guided towards the one or more “best” solutions (e.g., objective function optimum) in the swarm of candidate solutions. PSO can be applied to find solutions in varied applications, such as wireless networking, robotics, power systems, classification and training of artificial neural networks, and power systems.

PSO can be advantageous in that there are fewer parameters to tune as part of the process, and wider search spaces can be considered. However, PSO sometimes can be less advantageous in a high-dimensional search space, especially if time to reach a solution is a concern, because PSO converges at a very slow speed towards the global optimum. Sometimes PSO can fail to discover the global optimum solution in a reasonable number of iterations. In addition, one known issue with PSO is the so-called “local optima trap” or “local minima trap,” where there is a possibility to trap all particles in a local minimum (also called “local optimum”) in the solution space and the trapped particles cannot find the way out from the trap on their own. In some instances, this can lead to a premature convergence to a local optimum or local minimum, without reaching the global optimum solution.

Traditional task matching and assignment problems can often be optimized using Hungarian matching, as discussed above, but Hungarian matching is not advantageous for all types of task matching problems, such as if there are more tasks to be done than assets available to do them, or if task costs vary over time. Certain heuristic algorithms, such as the above-described PSO algorithm (PSO), also have been applied to solve such task matching and assignment problems, especially those of high complexity. However, because heuristic algorithms like PSO start the search randomly, these algorithms cannot guarantee to reach the optimization result, as noted above. Thus PSO is not the best optimization solution for all problems.

To help optimize in certain environments, it would be advantageous to develop a process using a technique that leverages the best features of both the Hungarian algorithm and PSO. Some processes have been developed to solve a problem first with the Hungarian algorithm to generate a cost matrix to optimize one constraining factor, such as a financial cost, and then applying PSO to the information in the generated cost matrix, to assess the cost matrix to see if the PSO solution converges to the same values. However, these types of processes have only been applied to optimize a single factor and not multiple factors; plus, these processes are using only one optimization at a time. Moreover, these processes do not use the cost features of the Hungarian algorithm to help refine each iteration of the swarm in the PSO, as is proposed for certain embodiments herein.

Other processes have been developed to attempt to run PSO on a plurality of particles to attempt to optimize to a single factor, wherein at each iteration, a random particle is selected to have a Hungarian algorithm run on it to see if it improves the optimization result for just that particle, and if the Hungarian algorithm does show improvement, that random particle is updated. However, that process version still can take too much time, optimizes only a single factor, and does not help to speed the convergence in the PSO to the best solution, for multiple factors, in a reasonable amount of time. Moreover, by applying the Hungarian cost matrix to only a single particle in the swarm at each iteration, where the single particle was selected randomly versus based on a specific analysis to determine if it is the most optimal, the rest of the swarm might converge towards a local minima and the gbest result might still lead the swarm into the aforementioned local minima trap, resulting in a solution that is not the most optimum.

In at least some embodiments herein, a solution is provided that is configured to create a lowest-cost schedule that takes advantage of varying costs of different assets performing different tasks as well as taking advantage of varying costs over time, by applying the Hungarian algorithm to the output of the PSO at each iteration (i.e., for each particle, the best particle location found during an iteration of a PSO swarm), to further refine the PSO solution based on cost, and then update particle locations based on the application of the Hungarian algorithm, and provide that information to the next iteration of the swarm.

In certain embodiments, the cost functions associated with the Hungarian algorithm are configured to take into account one or more conditions, such as application-specific conditions. For example, in some problem spaces, a first condition is that different assets can perform different tasks at varying costs. In addition, in some problem spaces, a second condition is that these costs may vary over time. At least some embodiments herein take advantage of both the first condition and the second condition, to find a true lowest-cost solution.

In at least some embodiments herein, a solution is provided that determines a lowest-cost schedule based on a unique and advantageous combination of two proven methods for optimization: the Hungarian algorithm and Particle Swarm Optimization (PSO), where the output of the Hungarian algorithm is used to compute the minimum cost for each particle at each iteration, helping to improve the converging behavior of the swarm and thus improve the optimization. The score for each particle in each iteration is determined via Hungarian matching. As noted above, Hungarian matching is a combinatorial optimization algorithm which focuses on matching different assets to different tasks to find the lowest cost, and PSO is an iterative heuristic algorithm which, given a time-based cost function, is able to find local minima by “moving” particles in the direction of the “best” particle position. Certain embodiments discussed herein use both optimization methods in tandem; for each particle in the PSO, various assets and tasks are provided to the Hungarian algorithm in order to calculate the minimum total cost. These particles then “swarm” to find the local minima (costs) at varying positions, in each iteration of the PSO.

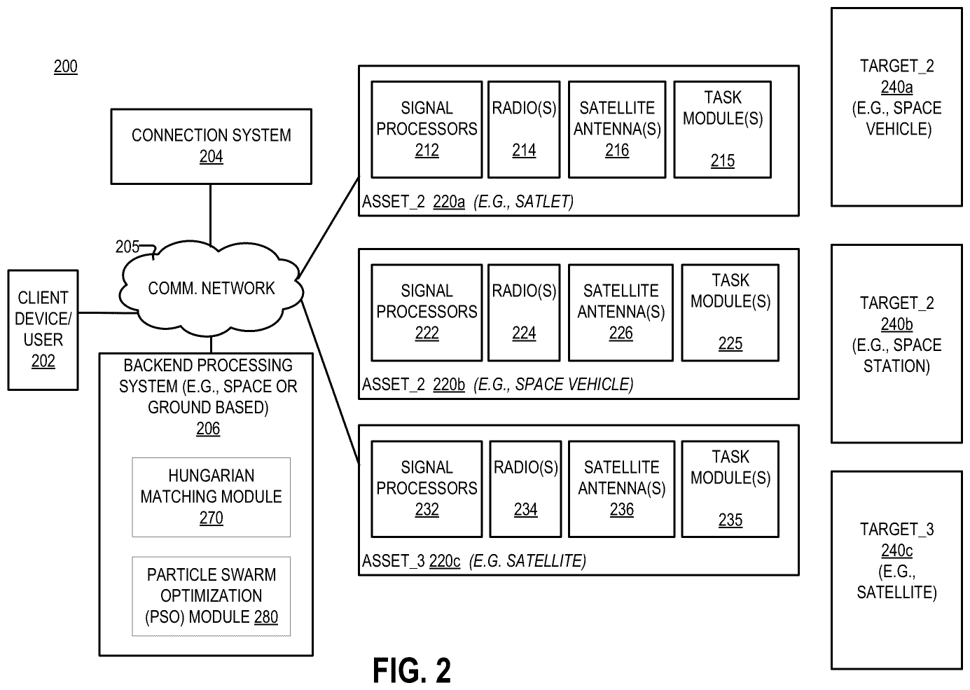

FIG. 2 is a simplified block diagram of an exemplary system 200 in accordance with one embodiment, which system 200 is usable to implement and illustrate at least some of the processes described herein. As illustrated, the system 200 may include a client device/user 202 operable by a user (where the user can be a human, a machine, a software program, or any other entity), a connection system 204, a backend processing system 206, a communications network 205, a plurality of assets 220a-220c (collectively “assets 220”), and a plurality of targets 240a-240c (collectively “targets 240”). The assets 220a-220b in the example system of FIG. 2 are shown to be space-based objects, each asset 220a-220c having a respective signal processors 212, 222, 232 (e.g., to process commands received and/or commands originating on the space object itself), a respective radio 214, 224, 234 and satellite antenna 216, 226, 236, for communication, and, optionally, a respective task module 215, 225, 235, which can be configured to enable the asset to perform a particular task.

Although FIG. 2 depicts an exemplary system 200 where the number of assets 220a-220c and number of targets 240a-240c are the same, the embodiments herein are not limited to having equal numbers of items to be matched or paired to each other. Various embodiments can have more assets than targets, or vice versa, as will be understood. For example, referring briefly to the environment of FIG. 1, it may be possible that a given ESPA mothership 102, 106 can be configured to have six satlets coupled thereto, all deployed simultaneously, but still only four possible targets that need to be serviced in some way, where the problem to be solved may be to determine which of the already-deployed satlets are the optimum ones to service the targets, based on various constraints (e.g., current location of the satlet, capabilities of the satlet, etc.).

The communications network 205 may include one or more of a local area network (LAN), a wide area network (WAN), the Internet, a wireless communications network, a closed network, a satellite or space communications network, and/or any other suitable type of communications network. The connection system 204 may include a computing system and/or an electronic system that is arranged to cause any of the assets 220a-220c to establish a connection (e.g., an uplink connection and/or a downlink connection, or any other type of connection) with a target 240a-240c, such as a manufactured space-based object.

Although in the example of FIG. 2, the connection system 204 and the backend processing system 206 are depicted as separate systems, it will be understood that in some implementations they may be integrated into the same system. Additionally, although in the example of FIG. 1 the client device/user 202 is depicted as being separate from the connection system 204 and the backend processing system 206, it will be understood that in some implementations the client device/user 202 may be integrated into one (or both) of the connection system 204 and the backend processing system 206. Furthermore, it will be understood that the connection system 204 and the backend processing system 206 may also be integrated together into the same system.

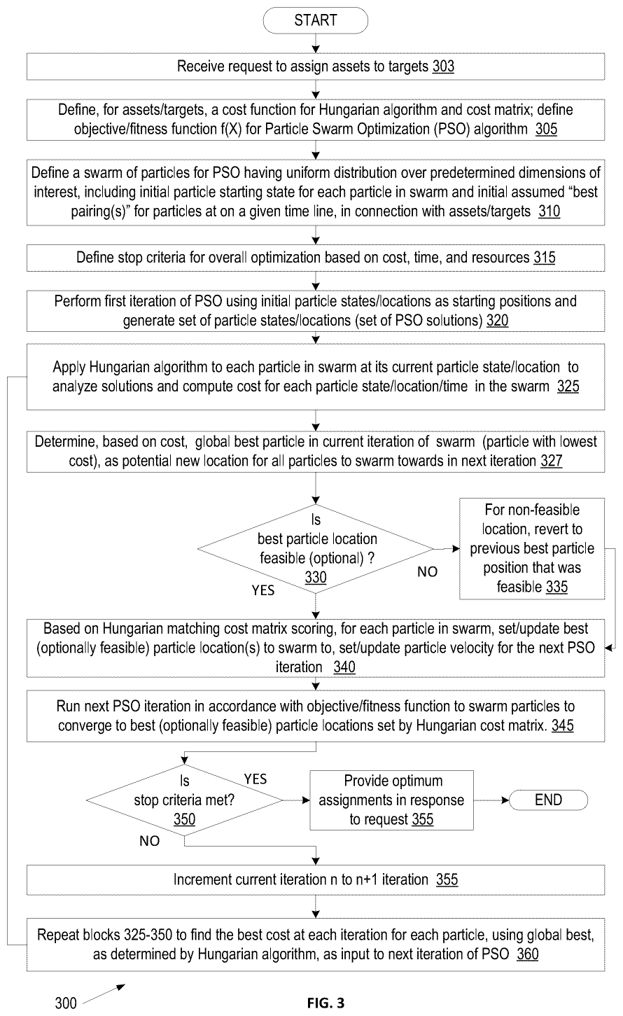

The backend processing system 206, in certain embodiments, includes one or more optimization modules configured to optimize requests received from the client device/user 202. In certain embodiments, the backend processing system 206 includes a Hungarian matching module 270 and a Particle Swarm Optimization (PSO) module 280, which are operable in accordance with the techniques discussed further below in connection with FIGS. 3-8.

One of skill in the art will appreciate that the assets 220a-220c are illustrative and not limiting. The system 200 of FIG. 2 can be implemented in and adapted to many other types of environments where optimization is needed and can be customized for operation on those environments with many types of functionalities. For example, in a context of optimizing land-based delivery of various types of cargo, certain assets can correspond to human-driven trucks, certain assets can correspond to driverless vehicles, and certain assets can correspond to rail vehicles. Each land-based vehicle asset may include respective application-specific processing systems and communications systems (e.g., to receive and respond to command), and, optionally, specific task modules or other task-specific features and equipment. For example, a first truck asset may include a specific attachments configured for the task of carrying certain types of cargo (e.g., construction equipment). Similarly, a driverless vehicle asset may be configured for a task of food delivery and include specific compartments configured to maintain deliveries it carries at a particular temperature. Likewise, a rail asset may include specific compartments configured to hold shipping containers received directly from a cargo ship. These assets may similarly need to be assigned to the most optimum tasks at various times.

Referring again to FIG. 2, during operation, the client device/user 202 may receive a user input specifying a request that certain tasks or actions be performed for one or more targets 240a-240c, advantageously using one or more of the assets 220a-220c (the responses these requests are what can be optimized, as discussed further herein). The request may include a requirement that the request be fulfilled in accordance with some constraint, such as fulfilling at lowest possible cost, or quickest possible time, etc. This request is sent over the communications network 205, and, in certain embodiments, the backend processing system 206 helps to convert the request into appropriate commands sent to the assets 220a-220c, where the conversion includes an optimization, using the techniques discussed herein (especially those of FIGS. 3-7, discussed further below), so that the request is fulfilled in accordance with the constraints. In some embodiments, the backend processing system 206 may present several options to the client device/user 202, based on its processing, and allow the client device/user 202 to select the option used.

The targets 240a-240c correspond to entities to be matched to assets 220a-220c, so that (depending on the application environment) each asset 220a-220c can be appropriately paired to or matched with at least one target 240a-240c, at certain instances in time, advantageously in some embodiments, to perform a specific task for, on behalf of, or on, the target 240a-240c. In some embodiments, depending on factors such as positions of the asset and target at different times within a time period, an asset 220a-220c may be paired with more than one target 240a-240c over the time period (e.g., asset 220a may be paired with target 240a at a first time within a time period and may be paired with target 240b at a second time within the time period, etc.).

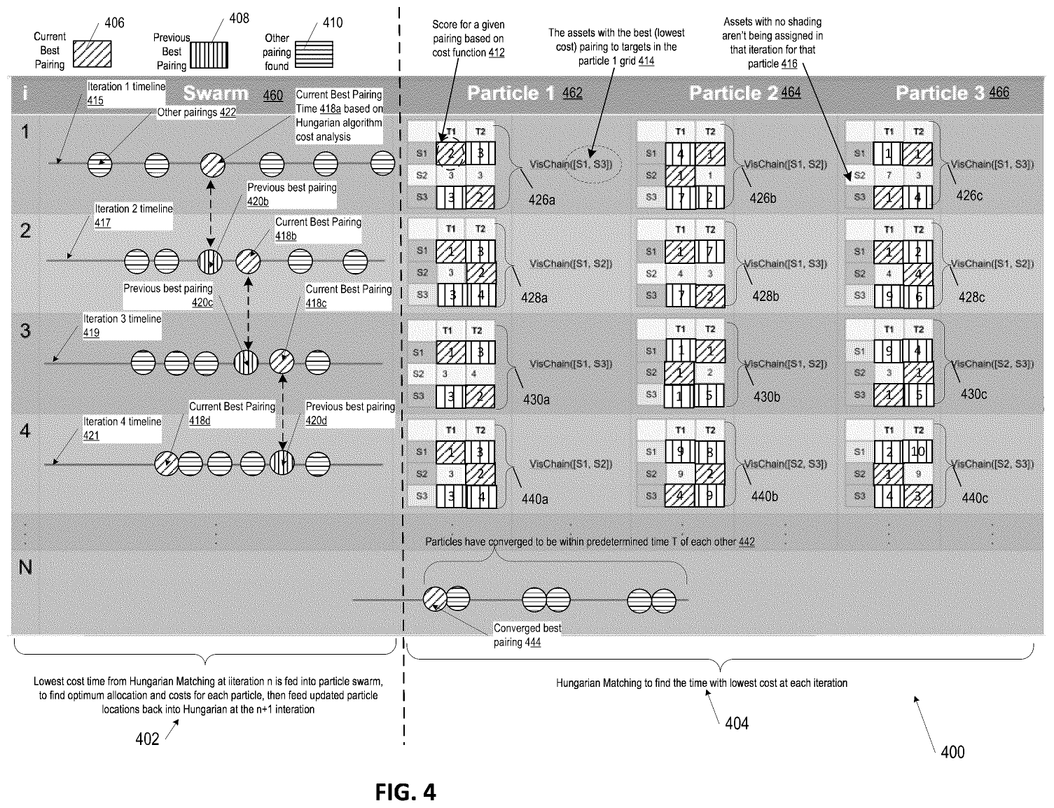

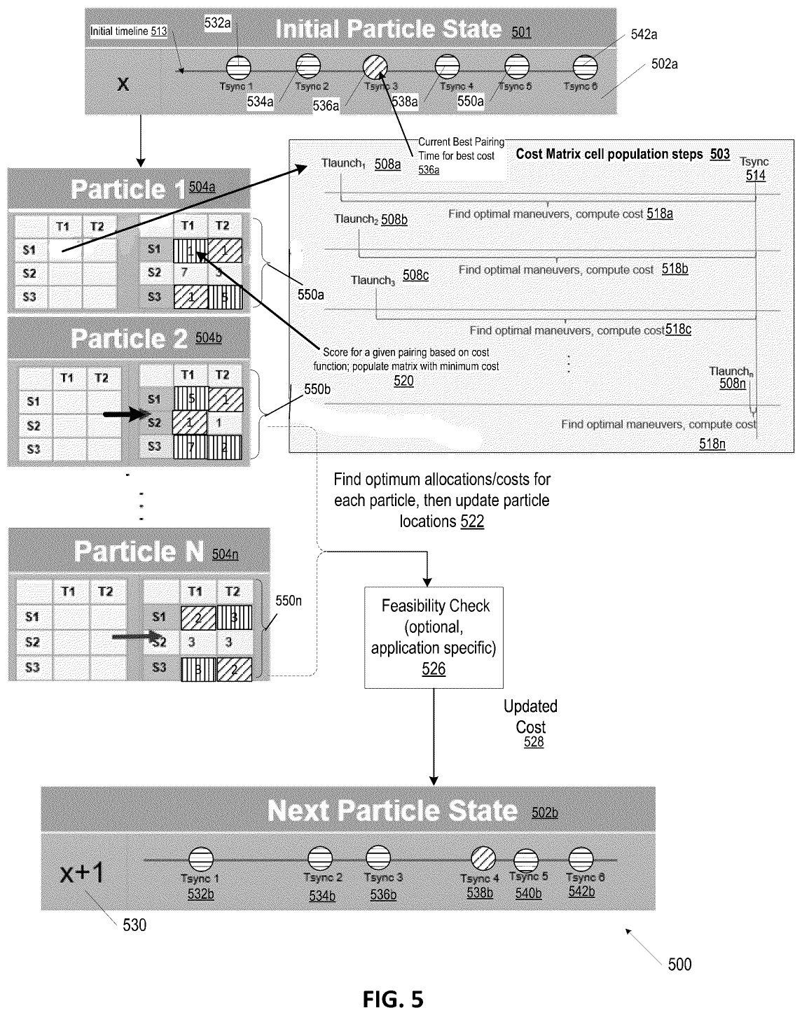

FIG. 3 is a flow chart 300 showing an optimization process/method operable in the system of FIG. 2, in accordance with one embodiment. In addition, FIGS. 4-7 help show the status of exemplary particles in a system (e.g., the system of FIG. 2, but this is not limiting) that is running the process of FIG. 3. FIG. 4 is a diagram 400 depicting operation of the system of FIG. 2 and the flowchart of FIG. 3, in accordance with one embodiment. FIG. 5 is a functional flow diagram 500 showing an example mode of operation for the system of FIG. 2 and the flowchart of FIG. 3, in accordance with one embodiment. Note that, in FIG. 4, the left side of the diagram (to the left of the dotted line down the middle) corresponds to an illustrative representation of part the PSO optimization portion 402 of the process of FIG. 3, and the right side of the diagram (to the right of the dotted line down the middle) corresponds to an illustrative representation of part of the Hungarian algorithm portion 404 of the process of FIG. 3. In FIG. 4, at the leftmost edge, each iteration “i” is labeled, from 1 to N (for simplicity, only four iterations are shown in FIG. 4).

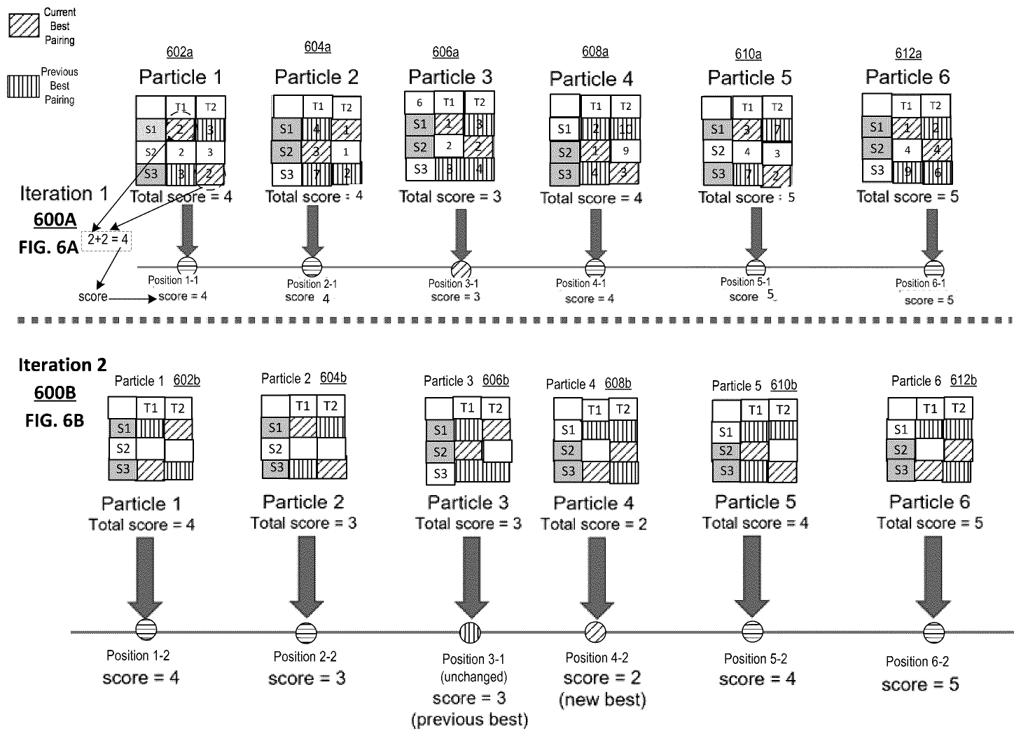

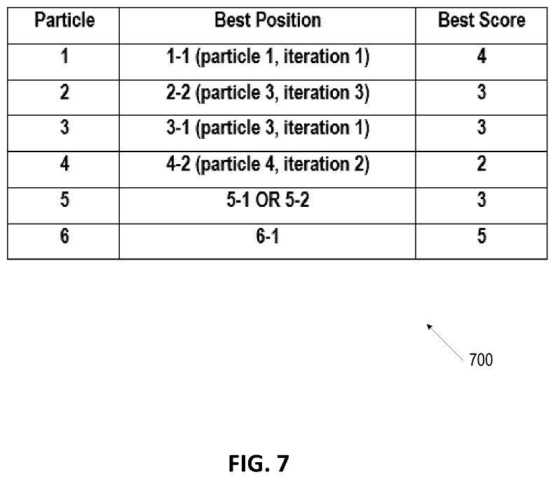

FIG. 6A, also referenced at times in connection with the process of FIG. 3, is an illustrative example showing a plurality of Hungarian cost matrices associated with a first iteration 600A of a particle swarm optimization, showing the global best particle in the first iteration, in accordance with the process of FIG. 3, in accordance with one embodiment. FIG. 6B is an illustrative example showing a plurality of Hungarian cost matrices associated with a second iteration 600B of a particle swarm optimization, showing the global best particle in the iteration, in accordance with the process of FIG. 3, in accordance with one embodiment. FIG. 7 is a table 700 showing how particles keep track of their own personal best match in accordance with the process of FIG. 3. FIGS. 4-7 will be referenced and described below in the discussion of FIG. 3, to help illustrate the operation of certain embodiments herein.

Referring first to the flowchart of FIG. 3, in block 303, a request is received to assign assets to targets (or to perform any other application-specific assignment). In block 305, certain functions are defined for the assets and targets. In particular, a cost function is defined for the Hungarian algorithm, which is used to populate the Hungarian cost matrices that are associated with each particle (e.g., the matrices 426a-440c in FIG. 4; the cost matrices 550a-550n of FIG. 5; the cost matrices 602a-612a in FIG. 6A; and the cost matrices 602b-612b of FIG. 6B). As those of skill in the art will appreciate, the appropriate cost function for use in any given problem with the Hungarian algorithm is application specific and depends on the application to which Hungarian application is being applied. The cost function generates a score that helps. In certain embodiments, the cost function returns a score that is used to populate the matrix.

For example, in the space environment of FIG. 1, an appropriate cost function may be based on one or more of the Lambert algorithms (e.g., a Lambert flight dynamics algorithm, but this is not limiting), which are used extensively for initial orbit determination, mission planning, space debris correlation, and missile targeting, as is understood in the art. In an exemplary embodiment, a Lambert flight dynamics algorithm is usable to help determine velocity and/or acceleration needed for satlets to reach targets within a certain time window, and so a cost function based on Lambert can help compute fuel consumption associated with different options for velocity and acceleration. For example, commonly assigned U.S. Pat. No. 9,352,858, entitled, “ANGLES-ONLY INITIAL ORBIT DETERMINATION (IOD)” (which is hereby incorporated by reference), discusses use of the Lambert problem and solution algorithms; those of skill in the art will appreciate that many different cost functions are usable in embodiments discussed herein. As is understood, for problems solved using the Hungarian algorithm, the cost function that is usable to help determine scores that can help to populate the Hungarian cost matrix, advantageously is configured to take into account costs that may vary based on one or more other factors or parameters, such as time, resources, etc. or which may vary depending on other parameters. One such example of a cost function, such as in the space environment of FIG. 1, would base itself on length of time, fuel consumption, and communications. In this example, the change in velocity (dV) is used to represent the amount of fuel used. This example assumes a maximum delta-V (maxDv), a maximum length of time to maneuver (maxDt), and the percentage of time that a satlet is in communication with its mothership in flight (comms) to be represented as a value between 0 and 1. Assuming dV and dT are weighted the same, the cost function, therefore, would be as shown in equation (1) below:

$$\frac{\frac{d V}{max Dv} + \frac{d T}{max Dt}}{comms} . \qquad ( 1 )$$

In some embodiments, the cost matrix for an environment 100 such as that in FIG. 1, may generate a score based at least in part on certain factors that are deemed to be important or optimal, such as (in an environment like the environment 100 of FIG. 1) visibility and/or ability to communicate with ground systems, such as percentage of time (during the pairing) that a satlet is able to communicate with a ground station, such as the tactical ops center 120 of FIG. 1. As discussed further herein, the output of the Hungarian algorithm is used at each iteration of a PSO process, to help set the next particle state and improve the swarming process by providing a “best” value that the swarm will swarm towards in the next iteration.

Referring again to block 305 of FIG. 3, the function f(X) for the PSO algorithm (referred to in the art as the objective function or fitness function, where X is a position vector), also is defined in block 305, though, of course, it could be defined in a separate block. As is understood in the art, the job of f(X) is to assess how good or bad a position X is; that is, how perfect a certain landing point a particle finds after finding a suitable place. As PSO iterates, this fitness function further refines to reveal local minima.

Referring again to FIG. 3, and also to FIG. 4, in block 310, an initial particle starting state is defined/assumed for each particle in the PSO swarm 460, with initial assumed “best pairing(s)” for particles on a given timeline, included in the initial state. As is understood in the art, with PSO, a preliminary step of the PSO is to initialize the swarm particle locations as well as define certain parameters associated with controlling the swarm, such as controlling how many iterations will take place, conditions indicative that an optimum position has been reached, convergence criteria, time limits, etc., and these actions take place in blocks 310 and 315 of FIG. 3. In certain embodiments, it may be advantageous in initialization associated with PSO for the positions of particles to be initialized so that they are configured to cover the desired search space in a substantially uniform allocation or spacing. Thus, referring to the example environment 100 of FIG. 1, if the particles in a PSO arrangement correspond to times at which tasks are performed in a synchronized fashion, in advance of the first iteration, advantageously could be configured to cover (as best as is known) the positions or possible positions of the targets within a defined time window when the targets to be serviced, are expected to be located. That is, each of the particles in the PSO refers to a time at which the tasks must occur. In other embodiments, the initial positions of the satlets correspond to their locations on the respective motherships 102, 106, for example.

In certain embodiments, efficiency of the PSO is influenced by the initial diversity of the swarm, i.e., how much of the search space is covered, and how well particles are distributed over the search space, because if the initial swarm does not cover regions of the search space, the PSO may have difficulty in finding the optimum if it is located within an uncovered region. Of course, the advantageous application of the Hungarian algorithm at each iteration for each particle, as discussed herein, to help choose the best asset-target pairing and compute this cost as input to the PSO at the next iteration, significantly improves the optimization of PSO and the resulting cost optimization, by improving the new global best towards which each particle will swarm in that next iteration.

FIG. 4 does not show the initial particle states or assumptions in connection with block 310, but FIG. 5 shows an exemplary initial particle state 501 with a set of initial synchronization points 532a-542a, for an initial timeline 513. FIG. 5 also shows the next particle state 502b at the X+1 iteration 530 with a set of next synchronization points 532b-542b. In FIG. 5, it can be seen that, for purposes of example, one time along the initial timeline 513 is set to be the “initial current best pairing” 536a (shown by the corresponding diagonal line pattern shading, similar to the diagonal line pattern shading key 406 in FIG. 4, to designate current best pairing and/or current best pairing time). The particle location associated with this assumed initial best pairing, is the initial starting time. For example, in the initial particle state 502a in FIG. 5, the “best” pairing 536a is initially assumed to be the third dot from the left along the timeline, with the diagonal pattern shading, but this is not (of course) limiting. As will be understood, the particle states reflected in the initial iteration correspond to assumed initial particle swarms and an assumed “best” point in time, but in the actual iterations (iteration 1 and beyond) the time on the timeline when the “best” pairing is shown, will correspond to an actual result from following the process of FIG. 3, where the “best” pairing for the PSO swarm 460 to swarm around, for each particle, will actually come from the Hungarian matching cost matrix as discussed herein.

Referring again back to the process of FIG. 3, in block 315, stop criteria is defined for when to stop the process and the PSO iterations (“stop criteria,” also is referred to in the art as a “stopping condition”). In certain embodiments, the stop criteria is based on at least one or more of cost, time, and resources. For example, a stop criteria can be set to be a condition when the optimization reaches a cost threshold (in whatever measure is being used to measure cost, such as dollars, time, etc.). In another example, in certain embodiments, the stop criteria can correspond to performing a predetermined number of iterations. In some embodiments, the stop criteria can correspond to a convergence type of criteria, such as a condition wherein the particles in the swarm are within a certain predetermined distance of each other or are disposed so as to be within predetermined time from each other, which can be indicative of a local minima, where particles may be converging towards a particular time or location. Advantageously, in certain embodiments, when defining stop criteria, two considerations are taken into account:
avoiding, if possible, selection of stop criteria that may cause the PSO to converge prematurely, which can result in suboptimal solutions; and
avoiding, if possible, selection of stop criteria that requires frequent recalculations within the iteration, which can increase computational complexity of the PSO process for searching for a solution.

Referring again to FIG. 3, after the cost function and fitness function are defined, after the swarm is defined and initialized (e.g., as shown in the initial particle state 502a of FIG. 5 and as discussed above) and after stop criteria are defined as discussed above, the first iteration of PSO can be performed (block 320) using the initial particle states as represented during timeline of the initial particle state 502a of FIG. 5 (block 320). In block 320, the first iteration of PSO is performed using the initial particle states/locations as starting positions, and this first iteration generates set of particle states/locations as a set of solutions. Note as well that the actions of blocks 305-315 can happen in any order, can be combined, can be further broken up, etc., but these actions advantageously happen before the particle swarming takes place, as will be appreciated. It is possible to define the Hungarian algorithm cost function at the same time or shortly after the first PSO, but the Hungarian algorithm is applied to the results of each iteration of the PSO, so it advantageously is ready to be applied by that time.

The output of the first iteration of the PSO, after applying the cost matrix, is shown in FIG. 4 as the iteration 1 timeline 415 for iteration 1, where each patterned dot on the timeline 415 represents a particle in the swarm at point in time. In FIG. 4, at the leftmost edge, each iteration “i” is labeled, from 1 to N (for simplicity, only four iterations are shown in FIG. 4). The shading on each particle as shown in FIG. 4 (and as explained in the FIG. 4 “key”) indicates whether or not that particle was the most optimum (lowest cost) particle in the swarm, as computed by the Hungarian algorithm, which is applied at each iteration, as described below. As explained herein, the location of the optimum particle in any given iteration “n” will be the location towards which the other particles swarm in the next iteration of the PSO (“n+1”). The particle “location” has a meaning that is application-specific. For example, in the context of the environment 100 of FIG. 1, a particle location may correspond to a certain set of pairings of satlets and targets at a specific time (this is reflected in the cost matrices of FIGS. 4, 5, 6A, and 6B herein). (Note that, in the illustrative examples, the timeline 415 after iteration 1 happens to be identical to initial timeline 513 for the initial particle state, but this is illustrative and not limiting.). Each of these timeline points are provided for each particle in the PSO swarm 460 and are used to help show what is the “current best pairing” 418a (FIG. 4) that the PSO swarm 460 converged towards, which can correspond to a local minima or maxima (depending on how the swarm is configured).

Thus, referring to FIGS. 3, 4 and 5, in block 325, the process applies the Hungarian algorithm and associated cost function to the set of solutions that were generated in the iteration of the PSO, i.e., each particle in the swarm at its current particle state and location. Block 325 helps to generate a cost for each particle in the swarm. In certain embodiments, the Hungarian algorithm is applied to each particle in the swarm at its current particle state/location to analyze solutions and compute the optimal cost scores for each particle state/location solution that results from the iteration of the PSO. The application of the Hungarian algorithm computes scores for the PSO solutions (e.g., pairings), using the Hungarian cost function defined in block 305, to determine optimum allocations/costs for each particle and scores for particle locations.

FIGS. 4-7 help to further illustrate what takes place in block 325 as the Hungarian algorithm is applied to the results of the first iteration of PSO, to compute scorings for the pairings at different timeline points and how particle scoring takes place. FIG. 4 shows exemplary cost matrices for a first iteration of the process of FIG. 3. For example, particle 1 462 of FIG. 4, in the first iteration, has a first cost matrix 426a, particle 2 464, in the first iteration, has a first cost matrix 426b, and particle 3, in the first iteration, has a respective first cost matrix 426c. FIG. 4 shows that each cell in each respective cost matrix, corresponds to a scoring for a given pairing based on the cost function 412 defined in block 305. For each particle in each iteration of FIG. 4, the text next to each cost matrix indicates the assets (e.g., satlets) with the best (lowest cost) pairing 414 to targets in the respective particle 1 cost matrix grid. For example, for cost matrix 426a, the assets with the best pairing 414 to targets are S1 and S3, and those are designated in the respective text next to cost matrix 426a. In addition, within the cost matrix, the assets are shaded slightly darker if they are being paired or assigned to targets in that iteration for the particle. Conversely, assets with no shading aren't being assigned in that iteration for that particle. Because there are more assets (S1, S2, S3) than targets (T1, T2), in this example, even if the possibility of pairing is scored, there need only be two best scores in each cost matrix, one for each target.

In the iteration 1 timeline 415, the point labeled as “current best pairing time for best cost,” 418a, corresponds to the best possible time for all assets to arrive at targets, with the best cost, where the best cost is derived based on the associated costs matrices for the particles (e.g., the cost matrices in FIG. 4 shown as the particle 1 cost matrix 426a, the particle 2 cost matrix 426b, and the particle 3 cost matrix 426c). This pairing time 418a will be the point in time around which the particles would try to swarm in the next iteration (e.g., iteration 2 in FIG. 4, as shown via its respective iteration 2 timeline 417).

Referring to FIG. 5, Section 503 of FIG. 5 shows, for certain embodiments, the Hungarian cost matrix cell population steps that show how population of the cost matrix takes place, by showing how the steps that happen for an exemplary pairing. The cost matrix cell population steps shown in section 503 of FIG. 5 depicts how the minimum pairing cost is determined for the S1-T1 pairing, for each iteration by computing the cost of each various possible maneuvers, at different times, trying to pair or match S1 to T1, based on data provided in accordance with the swarm fitness/object function. That is, the cost function for the Hungarian algorithm computes a cost that is determined by the optimal time to launch between time Tlaunch 508a to Tlaunch 508n, for example that will minimize delta-V for each asset-target pairing at that particular synchronization time Tsync 514, for each of a plurality of possible times during a given iteration of the swarm. For each possible Tsync 514 time in the swarm, from the optimal value of time Tlaunch 508a to time Tlaunch 508n (launch of the satlet, e.g.) to synchronization time Tsync 514 (when the satlet is projected to reach its target), optimal maneuvers are found and cost is computed 518a-518n. The minimum cost found during that iteration, for the given particle pairing (i.e., S1-T1 in this example), is what gets put into the Hungarian cost matrix 550a.

In FIG. 5, particle 1 504a illustrates how a given cost matrix goes from empty to full. The particle 1 504a in FIG. 5 shows possibilities that can arise from pairings of one of three assets (listed as “S1,” “S2,” and “S3”) with one of two targets (shown as “T1” and “T2”). For example, for purposes of illustration and not limitation, each asset can be viewed, e.g., as a satlet (e.g., as shown in the example environment 100 of FIG. 1) that could be paired to one of two targets (e.g., satellites or space vehicles needing a service, as shown in the example environment 100 of FIG. 1). The empty cost matrix for particle 1 504a shows empty cells corresponding to all the possible pairings that could have happened in the at any given synchronization time during the PSO. The section of FIG. 5 labeled as, “cost matrix cell population steps” 503 shows the actions taken to populate one exemplary cell in the particle 1 cost matrix 550aa; namely, the combination of S1 and T1.

As section 503 shows, the Hungarian algorithm is applied to data from the PSO relating to that particular pairing at each time instant. This is done for the data associated with each particle that swarmed during the PSO. Consider the combination or pairing of S1-T1. To achieve this combination, there are certain optimal maneuvers to be done at Tlaunch1 408 (a first launch time), certain optimal maneuvers to perform at Tlaunch2 4101, etc. At each launch time, as well, there is a cost to perform those maneuvers, and the Hungarian algorithm computes that cost. At the end of all the launch times considered during the particular iteration of the PSO (in this case, the first iteration), the minimum cost maneuver that was found, is what populates 520 the cost matrix 550a. This set of actions associated with section 503 is repeated for each combination in the cost matrix, and this is also repeated for each particle in the swarm, in connection with block 325 of FIG. 3, to fill the cost matrix for each particle with the best (minimum) costs found for that particle.

The above-described process of block 325 of FIG. 3 is repeated for each cell in the cost matrix (i.e., for each possible combination of asset and target), and this is repeated, as well, and for each particle in the swarm, and all of this is done at each iteration. As the exemplary cost matrix 550a shows, certain pairings had the lowest possible scores (in this example, a “low” score implies a lower cost, and thus is a “better” score). In the example Hungarian cost matrix 550a, it can be seen that the pairing S1-2 was the lowest cost pairing of T2 with any satlet that could service it, with a score of “1”, and the pairing of S3 with T1 was the lowest cost pairing of T2 with any satlet that could service it. Those pairings, shown in diagonal pattern shading, represent the “best pairings” during iteration 1. Even though there were possible pairings of S2 with either target, during this iteration of the swarm, none of those pairings had as low a cost as the S1-T2 pairing and the S1-T1 pairing. For example, the pairing of S2 with T1 had a score of 7, and the pairing of S2 with T2 had a score of 3.

It also can be seen, in the example cost matrix 550a of FIG. 5, that the previous best pairings (from the last iteration) also are scored and are indicated via a vertical line shading pattern. In the cost matrix 550a of FIG. 5, the previous best scores included a score of 1 for the S1-T1 pairing, and a score of 4 for the S3-T2 pairing. As the iterations progress, the previous best becomes more readily apparent. For example, referring to FIG. 4, consider iteration 1 of particle 2 and its associated cost matrix 426b, which shows that, in that iteration, the “best” scoring pairs are S1-T2 (with a score of 1) and S2-T1 (with a score of 1). In iteration 2 of particle 2 and its associated cost matrix 428b, the “best” scoring pairs from the first iteration (i.e., S1-T2 and S2-T1).

In certain embodiments, the Hungarian algorithm's cost function takes into account application specific factors that can lead to a better or worse score. For example, a given application may have as a specific factor, percent of time that a satlet is able to talk to a ground station, during a maneuver, as a factor that allows a score to be lower (lowest “cost”) the greater the percent of time that a satlet is able to remain in communication with the ground station during the maneuver. Another given application may have the best score be shortest time to complete a given task or maneuver. Other factors are possible, as will be understood. These aspects and variables in the cost function are what help to generate the score that appears in the Hungarian cost matrix, as will be understood.

As noted above, in iteration 1 in FIG. 4, corresponding to block 310 of FIG. 3, the initial particle states show that one of the pairings, at a particular synchronization time (in this example “Tsync 3”) has been computed (in the cost matrices 426a-426c) to be the “best” the best pairing 418a, and is shown with diagonal shading. The other pairings 422 of FIG. 4 are other pairings that were found, but which are not the “best” pairing. For simplicity, in FIG. 4, the particle swarm comprises only 6 particles, and the details of the cost matrices for only 3 of these particles is shown, but that is not limiting, and those of skill in the art will understand how additional cost matrices for the other particles, are being generated.

FIG. 5 likewise shows the same particle, at the same synchronization spot in the timeline, with the same shading, to be initialized to be the “best” initial pairing. Of course, the selection of which particle to initialize to the be the “best” is not limited to the selections shown in FIGS. 4 and 5; the particular best pairing and synchronization time are merely illustrative. In iteration 1 of FIG. 4, the “other” pairings 422, represent other pairings that were found at other times, but which are not considered to be the “best” in this assumed initial state (by best, it is meant that it is the point about which the post particles swarmed towards).

Thus, in block 325, the Hungarian algorithm is applied to each particle in the swarm, at its current location, to compute cost scores for each particle location. For example, referring to FIG. 4, the Hungarian algorithm is applied to each particle in the swarm at its current particle state at each point along the iteration 1 timeline 415, to determine which time along the timeline has the particle with the most optimum (lowest) cost. The iteration 1 timeline shows a particle labeled as “Current Best Pairing Time 418a based on Hungarian algorithm cost analysis”. The analysis in blocks 325 and 327 is what helps to determine that this time, of this particle, is the best possible time to match assets to targets (or to do whatever assignment is being considered), because this time enables pairing/matching/other assignment, at the most optimum (lowest) cost. In the example environment 100 of FIG. 1, for example, this would be the best time for all satlets to reach their targets. Thus, as part of blocks 325 and 327, as well as block 340, the cost function is used to help compute scores for each pairing. This helps determine optimum allocations/costs for each particle and scores for particle locations and pairings resulting in that iteration of the swarm, which can help achieve the function of “find optimum allocations/costs for each particle, then update particle locations” 522 of FIG. 5.

In block 327, a determination is made, based on these cost scores, regarding which is the global best particle (or which are the global best particles, in the case of a tie, which can be more common when cost functions are integer values) in the current iteration of the swarm; that is, the particle with the lowest cost. The global best particle will be potentially the new location for all particles to swarm towards in the next iteration of the PSO (depending on the optional feasibility check, discussed below). As part of blocks 325 and 327, all cost matrices for the particles are attempting to find the time that provides the lowest cost pairings, where “cost” is determined by applying the Hungarian cost function (defined in block 305) to score each pairing of each particle, where that resultant score is put into a respective cell in the cost matrix for that particle and pairing.

To further understand the exemplary computations in blocks 325 and 327, reference is made briefly to FIGS. 6A and 6B, which show the cost matrices associated with first and second iterations of an exemplary PSO swarm that goes through the process of FIG. 3. Referring first to the first iteration 600A of FIG. 6A, it can be seen that the swarm has six particles: particle 1 602a, particle 2 604a, particle 3 606a, particle 4 608a, particle 5 610a, and particle 6 612a. As shown for particle 1 602a, the total score is computed by taking the two lowest scoring combinations (where low score is preferable), i.e., the score of 2 for the S1-T1 pairing, and the score of 2 for the S3-T2 pairing. This results in a “total score” for particle 1 of 5. Thus, in the listing of the first iteration 600A (“iteration 1”) particles, particle 1 601a, which has position 1-1 in the iteration (indicating position 1 in iteration number 1), has a score of 4. The scores are computed similarly for the other particles in the other positions within iteration 1.

Referring to FIG. 6A, within the first iteration 600A, particle 3 606a is the global best, because it has the lowest total score of all the particles in that iteration. In the next iteration (second iteration 600B, shown as “iteration 2”), the method of FIG. 3 updates particle locations to the location with best cost as determined by Hungarian algorithm. Because particle 3 606a was the global best in the first iteration, in the next iteration the remaining particles will swarm towards particle 3 (i.e., the position of particle 3). In certain embodiments, in case there is a tie, the “best” score is arbitrarily chosen. As FIG. 6B shows, in the second iteration 600B (“iteration 2”), it can be seen that the new scores (which are computed again via the Hungarian matrices, in accordance with FIG. 3) show that particle 4 608b, in iteration 2, has the new best global score (gbest), because its total score is the lowest. The iteration 2 of FIG. 6B also indicated that the position of particle 3 did not change (since it was the previous best particle to swarm towards). That is, particle 3 attempted to swarm towards the same position it settled on in iteration 1.

Note, as well, that each particle keeps track of its own personal best cost score (pbest). This is depicted in the table of FIG. 7, which shows exemplary best positions for the six exemplary particles depicted in FIGS. 6A-6B.

Referring again to FIG. 3, in block 330, in certain embodiments, an optional check is performed to determine if the best particle location (as found in blocks 325-327) is feasible. This feasibility check also is shown in FIG. 5 as an optional, application-specific feasibility check 526. Depending on the application, it may be possible that what turned out to be the “best” particle location, is actually not a feasible location in all embodiments of the actual application. For example, in the example environment 100 of FIG. 1, it may be that the best time/location that has the lowest fuel travel time costs, as found during PSO, ends up being a location with poor communication quality to a home base location (which might be essential during certain applications and/or actions). One of skill in the art will appreciate that various applications may also have other feasibility checks applicable to the specific application. If the answer at block 330 is yes (the “best” particle location is feasible), that location will be used to update the location that the other particles swarm towards in block 340. If, however, the location is not feasible, then the particle's cost is set to a significantly greater value (e.g., maximum cost).

In block 340, based on the above-described Hungarian cost matrix scoring, for each particle in the swarm, the location of the best-scoring particle in the previous iteration, is set as the best particle location to swarm to in the next iteration, so the particle location and velocity are set to that for the next iteration. As discussed above, each particle has stored the position of its own personal best (pbest) (FIG. 7). In accordance with block 340, the particles change their position through a mechanism that incorporates a velocity that is generated based on the pbest position and also on the global best (gbest), which is determined herein using the Hungarian algorithm and cost matrix.

In block 345, the next PSO iteration is run in accordance with the defined objective/fitness function, to swarm the particles to converge to the best (and optionally feasible) particle locations as set by the Hungarian cost matrix. If the stop criteria is not met (answer at block 350 is “No”, then the iteration is incremented (block 355) and the process is repeated (block 360) for each particle, using the Hungarian matching analysis (as described above) to help determine the global best as the input to the next iteration of the PSO. As part of this, the updated cost 528 (FIG. 5) is provided to the next iteration (i.e., the X+1 iteration 530). If the stop criteria is met (answer at block 350 is “Yes”) then the optimum assignments are provided in response to the request of block 303, and the process ends.

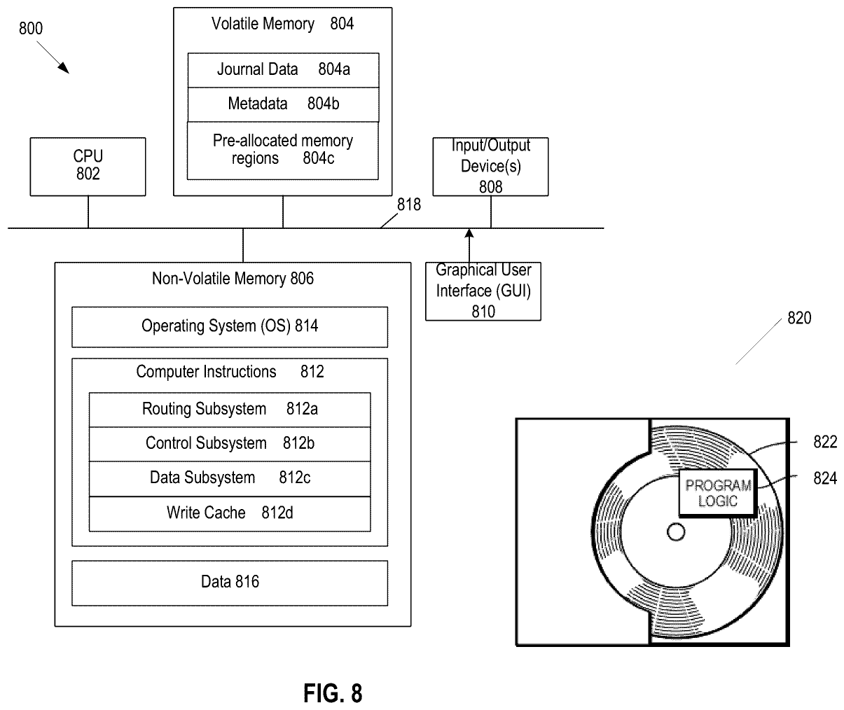

FIG. 8 is a block diagram of an exemplary computer system 800 usable with at least some of the systems and apparatuses of FIGS. 1-7, in accordance with one embodiment, to help to implement at least the method of FIG. 3 and in certain embodiments may be usable to provide or help to implement one or both of the assets/resources and targets. Reference is made briefly to FIG. 8, which shows a block diagram of a computer system 800 usable with at least some embodiments. The computer system 800 also can be used to implement all or part of any of the methods, equations, and/or calculations described herein.

As shown in FIG. 8, computer system 800 may include processor/central processing unit (CPU) 802, volatile memory 804 (e.g., RAM), non-volatile memory 806 (e.g., one or more hard disk drives (HDDs), one or more solid state drives (SSDs) such as a flash drive, one or more hybrid magnetic and solid state drives, and/or one or more virtual storage volumes, such as a cloud storage, or a combination of physical storage volumes and virtual storage volumes), graphical user interface (GUI) 810 (e.g., a touchscreen, a display, and so forth) and input and/or output (I/O) device 808 (e.g., a mouse, a keyboard, etc.), which may all be in operable communication via bus 818. Non-volatile memory 806 stores, e.g., journal data 804a, metadata 804b, and pre-allocated memory regions 804c. The non-volatile memory, 806 can include, in some embodiments, an operating system 814, and computer instructions 812, and data 816. In certain embodiment, the non-volatile memory 806 is configured to be a memory storing instructions that are executed by a processor, such as processor/CPU 802. In certain embodiments, the computer instructions 812 are configured to provide several subsystems, including a routing subsystem 812A, a control subsystem 812b, a data subsystem 812c, and a write cache 812d. In certain embodiments, the computer instructions 812 are executed by the processor/CPU 802 out of volatile memory 804 to implement and/or perform at least a portion of the systems and processes shown in FIGS. 1-7. Program code also may be applied to data entered using an input device or GUI 88 or received from I/O device 808.

The systems, architectures, and processes of FIGS. 1-8 are not limited to use with the hardware and software described and illustrated herein and may find applicability in any computing or processing environment and with any type of machine or set of machines that may be capable of running a computer program and/or of implementing a radar system (including, in some embodiments, software defined radar). The processes described herein may be implemented in hardware, software, or a combination of the two. The logic for carrying out the methods discussed herein may be embodied as part of the computer system described in FIG. 8. The processes and systems described herein are not limited to the specific embodiments described, nor are they specifically limited to the specific processing order shown. Rather, any of the blocks of the processes may be re-ordered, combined, or removed, performed in parallel or in serial, as necessary, to achieve the results set forth herein.

Processor/CPU 802 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs). In some embodiments, the “processor” may be embodied in one or more microprocessors with associated program memory. In some embodiments, the “processor” may be embodied in one or more discrete electronic circuits. The “processor” may be analog, digital, or mixed signal. In some embodiments, the “processor” may be one or more physical processors or one or more “virtual” (e.g., remotely located or “cloud”) processors.

Various functions of circuit elements may also be implemented as processing blocks in a software program. Such software may be employed in, for example, one or more digital signal processors, microcontrollers, or general-purpose computers. Described embodiments may be implemented in hardware, a combination of hardware and software, software, or software in execution by one or more physical or virtual processors.

Some embodiments may be implemented in the form of methods and apparatuses for practicing those methods. Described embodiments may also be implemented in the form of program code, for example, stored in a storage medium, loaded into and/or executed by a machine, or transmitted over some transmission medium or carrier, such as over electrical wiring or cabling, through fiber optics, or via electromagnetic radiation. A non-transitory machine-readable medium may include but is not limited to tangible media, such as magnetic recording media including hard drives, floppy diskettes, and magnetic tape media, optical recording media including compact discs (CDs) and digital versatile discs (DVDs), solid state memory such as flash memory, hybrid magnetic and solid-state memory, non-volatile memory, volatile memory, and so forth, but does not include a transitory signal per se. When embodied in a non-transitory machine-readable medium and the program code is loaded into and executed by a machine, such as a computer, the machine becomes an apparatus for practicing the method.

When implemented on one or more processing devices, the program code segments combine with the processor to provide a unique device that operates analogously to specific logic circuits. Such processing devices may include, for example, a general-purpose microprocessor, a digital signal processor (DSP), a reduced instruction set computer (RISC), a complex instruction set computer (CISC), an application specific integrated circuit (ASIC), a field programmable gate array (FPGA), a programmable logic array (PLA), a microcontroller, an embedded controller, a multi-core processor, and/or others, including combinations of one or more of the above. Described embodiments may also be implemented in the form of a bitstream or other sequence of signal values electrically or optically transmitted through a medium, stored magnetic-field variations in a magnetic recording medium, etc., generated using a method and/or an apparatus as recited in the claims.

For example, when the program code is loaded into and executed by a machine, such as the computer of FIG. 8, the machine becomes an apparatus for practicing one or more of the described embodiments. When implemented on one or more general-purpose processors, the program code combines with such a processor to provide a unique apparatus that operates analogously to specific logic circuits. As such a general-purpose digital machine can be transformed into a special purpose digital machine. FIG. 9 shows Program Logic 824 embodied on a computer-readable medium 820 as shown, and wherein the Logic is encoded in computer-executable code thereby forms a Computer Program Product 822. The logic may be the same logic on memory loaded on processor. The program logic may also be embodied in software modules, as modules, or as hardware modules. A processor may be a virtual processor or a physical processor. Logic may be distributed across several processors or virtual processors to execute the logic.

In some embodiments, a storage medium may be a physical or logical device. In some embodiments, a storage medium may consist of physical or logical devices. In some embodiments, a storage medium may be mapped across multiple physical and/or logical devices. In some embodiments, storage medium may exist in a virtualized environment. In some embodiments, a processor may be a virtual or physical embodiment. In some embodiments, a logic may be executed across one or more physical or virtual processors.

For purposes of illustrating the present embodiments, the disclosed embodiments are described as embodied in a specific configuration and using special logical arrangements, but one skilled in the art will appreciate that the device is not limited to the specific configuration but rather only by the claims included with this specification. In addition, it is expected that during the life of a patent maturing from this application, many relevant technologies will be developed, and the scopes of the corresponding terms are intended to include all such new technologies a priori.

The terms “comprises,” “comprising”, “includes”, “including”, “having” and their conjugates at least mean “including but not limited to”. As used herein, the singular form “a,” “an” and “the” includes plural references unless the context clearly dictates otherwise. Various elements, which are described in the context of a single embodiment, may also be provided separately or in any suitable subcombination. It will be further understood that various changes in the details, materials, and arrangements of the parts that have been described and illustrated herein may be made by those skilled in the art without departing from the scope of the following claims.

Throughout the present disclosure, absent a clear indication to the contrary from the context, it should be understood individual elements as described may be singular or plural in number. For example, the terms “circuit” and “circuitry” may include either a single component or a plurality of components, which are either active and/or passive and are connected or otherwise coupled together to provide the described function. Additionally, terms such as “message” and “signal” may refer to one or more currents, one or more voltages, and/or or a data signal. Within the drawings, like or related elements have like or related alpha, numeric or alphanumeric designators. Further, while the disclosed embodiments have been discussed in the context of implementations using discrete components, including some components that include one or more integrated circuit chips), the functions of any component or circuit may alternatively be implemented using one or more appropriately programmed processors, depending upon the signal frequencies or data rates to be processed and/or the functions being accomplished.

Similarly, in addition, in the Figures of this application, in some instances, a plurality of system elements may be shown as illustrative of a particular system element, and a single system element or may be shown as illustrative of a plurality of particular system elements. It should be understood that showing a plurality of a particular element is not intended to imply that a system or method implemented in accordance with the disclosure herein must comprise more than one of that element, nor is it intended by illustrating a single element that the any disclosure herein is limited to embodiments having only a single one of that respective elements. In addition, the total number of elements shown for a particular system element is not intended to be limiting; those skilled in the art can recognize that the number of a particular system element can, in some instances, be selected to accommodate the particular user needs.

In describing and illustrating the embodiments herein, in the text and in the figures, specific terminology (e.g., language, phrases, product brands names, etc.) may be used for the sake of clarity. These names are provided by way of example only and are not limiting. The embodiments described herein are not limited to the specific terminology so selected, and each specific term at least includes all grammatical, literal, scientific, technical, and functional equivalents, as well as anything else that operates in a similar manner to accomplish a similar purpose. Furthermore, in the illustrations, Figures, and text, specific names may be given to specific features, elements, circuits, modules, tables, software modules, systems, etc. Such terminology used herein, however, is for the purpose of description and not limitation.

Although the embodiments included herein have been described and pictured in an advantageous form with a certain degree of particularity, it is understood that the present disclosure has been made only by way of example, and that numerous changes in the details of construction and combination and arrangement of parts may be made without departing from the spirit and scope of the described embodiments. Having described and illustrated at least some the principles of the technology with reference to specific implementations, it will be recognized that the technology and embodiments described herein can be implemented in many other, different, forms, and in many different environments. The technology and embodiments disclosed herein can be used in combination with other technologies. In addition, all publications and references cited herein are expressly incorporated herein by reference in their entirety. Individual elements of different embodiments described herein may be combined to form other embodiments not specifically set forth above. Various elements, which are described in the context of a single embodiment, may also be provided separately or in any suitable sub-combination. It should also be appreciated that other embodiments not specifically described herein are also within the scope of the following claims.

1. A method, comprising:
(a) receiving a request for an answer to a problem, the problem comprising an optimum assignment of a plurality of first entities to a plurality of second entities;
(b) defining, for the plurality of first entities and plurality of second entities, a particle swarm optimization (PSO), the PSO associated with a swarm comprising a plurality of particles, each particle having a respective particle location representative of at least one assignment of at least one first entity from the plurality of first entities to at least one second entity of the plurality of second entities, wherein the PSO is configured to determine at least one solution to the optimum assignment of the plurality of first entities to the plurality of second entities;
(c) defining, for the plurality of first entities and plurality of second entities, a cost matrix configured to analyze each solution determined in the PSO in accordance with a Hungarian algorithm, wherein the cost matrix is configured to optimize at least one constraint associated with the plurality of first entities and plurality of second entities;
(d) running a first iteration of the PSO on the plurality of first entities and plurality of second entities, to generate a first set of PSO solutions corresponding to at least one potential answer to the problem, each PSO solution corresponding to a respective particle at a respective particle location;
(e) applying the cost matrix to the first set of PSO solutions generated to determine a cost score for each respective particle; and
(f) selecting the solution having the particle with best cost score, in the first set of PSO solutions, to be an optimized global best particle location for a next iteration of the PSO.

2. The method of claim 1, further comprising:
(g) running a next iteration of the PSO using the optimized global best particle location determined in (e) as a location towards which particles in the PSO will swarm during the next iteration of the PSO, the next iteration generating an updated set of PSO solutions; and
(h) returning a response to the request, the response to the request comprising a global best particle location from the next iteration of the PSO.

3. The method of claim 2, wherein the global best particle location from the next iteration of the PSO provides information necessary to provide a recommendation for the optimum assignment of the plurality of first entities to the plurality of second entities.

4. The method of claim 1, further comprising:
(g) running a next iteration of the PSO using the optimized global best particle location determined in (e) as a location towards which particles in the PSO will swarm during the next iteration of the PSO, the next iteration generating an updated set of PSO solutions;
(h) repeating steps (e) through (g) until a predetermined stop criteria is reached; and
(i) returning a response to the request, the response to the request comprising a global best particle location based on the most recent iteration of the PSO that ran before the predetermined stop criteria was reached.

5. The method of claim 4, wherein the response to the request comprises information necessary to provide a recommendation for the optimum assignment of the plurality of first entities to the plurality of second entities.

6. The method of claim 1, wherein at least one of the plurality of first entities and the plurality of second entities comprises at least one of: a task to be performed, an entity capable of performing a task, an entity configured for having a task performed on it, a method of performing a task, a path for performing a task, a location for performing a task, a resource for performing a task, and an asset for performing a task.

7. The method of claim 1, wherein the constraint comprises at least one of: cost, time, efficiency, power consumption, resource utilization, and growth, a factor to be maximized, and an undesired effect to be minimized.

8. The method of claim 1, wherein each respective particle location corresponds to an assignment of at least one first entity from the plurality of first entities to at least one second entity of the plurality of second entities, at a specific time.

9. A system, comprising:
a processor; and
a non-volatile memory in operable communication with the processor and storing computer program code that when executed on the processor causes the processor to execute a process operable to perform the operations of:
(a) receiving a request for an answer to a problem, the problem comprising an optimum assignment of a plurality of first entities to a plurality of second entities;
(b) defining, for the plurality of first entities and plurality of second entities, a particle swarm optimization (PSO), the PSO associated with a swarm comprising a plurality of particles, each particle having a respective particle location representative of at least one assignment of at least one first entity from the plurality of first entities to at least one second entity of the plurality of second entities, wherein the PSO is configured to determine at least one solution to the optimum assignment of the plurality of first entities to the plurality of second entities;
(c) defining, for the plurality of first entities and plurality of second entities, a cost matrix configured to analyze each solution determined in the PSO in accordance with a Hungarian algorithm, wherein the cost matrix is configured to optimize at least one constraint associated with the plurality of first entities and plurality of second entities;
(d) running a first iteration of the PSO on the plurality of first entities and plurality of second entities, to generate a first set of PSO solutions corresponding to at least one potential answer to the problem, each PSO solution corresponding to a respective particle at a respective particle location;
(e) applying the cost matrix to the first set of PSO solutions generated to determine a cost score for each respective particle; and
(f) selecting the solution having the particle with best cost score, in the first set of PSO solutions, to be an optimized global best particle location for a next iteration of the PSO.

10. The system of claim 9, further comprising providing computer program code that when executed on the processor causes the processor to perform the operations of:
(g) running a next iteration of the PSO using the optimized global best particle location determined in (e) as a location towards which particles in the PSO will swarm during the next iteration of the PSO, the next iteration generating an updated set of PSO solutions;
(h) repeating steps (e) through (g) until a predetermined stop criteria is reached; and
(i) returning a response to the request, the response to the request comprising a global best particle location based on the most recent iteration of the PSO that ran before the predetermined stop criteria was reached.

11. The system of claim 10, wherein the response to the request comprises information necessary to provide a recommendation for the optimum assignment of assign the plurality of first entities to the plurality of second entities.

12. The system of claim 9, further comprising providing computer program code that when executed on the processor causes the processor to perform the operations of:
(g) running a next iteration of the PSO using the optimized global best particle location determined in (e) as a location towards which particles in the PSO will swarm during the next iteration of the PSO, the next iteration generating an updated set of PSO solutions; and
(h) returning a response to the request, the response to the request comprising a global best particle location from the next iteration of the PSO.

13. The system of claim 12, wherein the global best particle location from the next iteration of the PSO provides information necessary to provide a recommendation for the optimum assignment of assign the plurality of first entities to the plurality of second entities.

14. The system of claim 9, wherein the constraint comprises at least one of: cost, time, efficiency, power consumption, resource utilization, and growth, a factor to be maximized, and an undesired effect to be minimized.

15. The system of claim 9, wherein each respective particle location corresponds to an assignment of at least one first entity from the plurality of first entities to at least one second entity of the plurality of second entities, at a specific time.

16. The system of claim 9, wherein at least one of the plurality of first entities and the plurality of second entities comprises at least one of: a task to be performed, an entity capable of performing a task, an entity configured for having a task performed on it, a method of performing a task, a path for performing a task, a location for performing a task, a resource for performing a task, and an asset for performing a task.

17. A computer program product including a non-transitory computer readable storage medium having computer program code encoded thereon that when executed on a processor of a computer causes the computer to operate a computer system, the computer program product comprising:
(a) computer program code for receiving a request for an answer to a problem, the problem comprising an optimum assignment of a plurality of first entities to a plurality of second entities;
(b) computer program code for defining, for the plurality of first entities and plurality of second entities, a particle swarm optimization (PSO), the PSO associated with a swarm comprising a plurality of particles, each particle having a respective particle location representative of at least one assignment of at least one first entity from the plurality of first entities to at least one second entity of the plurality of second entities, wherein the PSO is configured to determine at least one solution to the optimum assignment of the plurality of first entities to the plurality of second entities;
(c) computer program code for defining, for the plurality of first entities and plurality of second entities, a cost matrix configured to analyze each solution determined in the PSO in accordance with a Hungarian algorithm, wherein the cost matrix is configured to optimize at least one constraint associated with the plurality of first entities and plurality of second entities;
(d) computer program code for running a first iteration of the PSO on the plurality of first entities and plurality of second entities, to generate a first set of PSO solutions corresponding to at least one potential answer to the problem, each PSO solution corresponding to a respective particle at a respective particle location;
(e) computer program code for applying the cost matrix to the first set of PSO solutions generated to determine a cost score for each respective particle; and
(f) computer program code for selecting the solution having the particle with best cost score, in the first set of PSO solutions, to be an optimized global best particle location for a next iteration of the PSO.

18. The computer program product of claim 17, further comprising:
(g) computer program code for running a next iteration of the PSO using the optimized global best particle location determined by the computer program code in (e) as a location towards which particles in the PSO will swarm during the next iteration of the PSO, the next iteration generating an updated set of PSO solutions; and
(h) computer program code for returning a response to the request, the response to the request comprising a global best particle location from the next iteration of the PSO.

19. The computer program product of claim 18, wherein the global best particle location from the next iteration of the PSO provides information necessary to provide a recommendation for the optimum assignment of the plurality of first entities to the plurality of second entities.

20. The computer program product of claim 17, further comprising:
(g) computer program code for running a next iteration of the PSO using the optimized global best particle location determined by the computer program code in (e) as a location towards which particles in the PSO will swarm during the next iteration of the PSO, the next iteration generating an updated set of PSO solutions;
(h) repeating actions with the computer program code (e), the computer program code (f), and the computer program code (g) until a predetermined stop criteria is reached; and
(i) returning a response to the request, the response to the request comprising a global best particle location based on the most recent iteration of the PSO that ran before the predetermined stop criteria was reached;
wherein the response to the request comprises information necessary to provide a recommendation for the optimum assignment of the plurality of first entities to the plurality of second entities.
